(19) United States
(12) Patent Application Publication
(10) Pub. No.: US 2011/0128564 A1
(43) Pub. Date: Jun. 2, 2011

(54) IMAGE FORMING APPARATUS AND CONTROL METHOD THEREFOR

(75) Inventor: Hiroyuki Kayama, Yokohama-shi (JP)

(73) Assignee: CANON KABUSHIKI KAISHA, Tokyo (JP)

(21) Appl. No.: 12/911,151

(22) Filed: Oct. 25, 2010

(30) Foreign Application Priority Data
Dec. 2, 2009 (JP) 2009-274934

(51) Int. Cl. G06F 15/00

(52) U.S. Cl. 358/1.13

(57) ABSTRACT

An image forming apparatus configured to execute functions determines whether an another apparatus can operate a target function, enables display used for causing a user to input an instruction for causing the other apparatus to operate the target function when the other apparatus can operate the target function, transmits information used by the other apparatus in order to operate the target function, to the other apparatus, in response to input the instruction, and accepts an operation from the other apparatus, being inputted on the other apparatus by using the information, and executes the target function. In response to input the instruction, the display control unit controls a default screen so as to being capable of newly operating for executing a function. The function execution unit accepts an operation related to a function different from that being operated from the other apparatus and being executed, and executes the different function.

### BACKGROUND OF THE INVENTION

1. Field of the Invention

The present invention relates to an image forming apparatus for executing various functions by operating a display screen, and a control method for the image forming apparatus.

2. Description of the Related Art

In conventional image forming apparatuses, a technique in which a plurality of apparatuses execute processing in place of the operation unit of another apparatus is well known (see, for example, Japanese Patent Laid-Open No. 2001-156754). This technique enables another apparatus to execute processing on behalf of an apparatus which cannot be used, thereby improving operability.

In the above-described technique, however, if an alternative apparatus cannot execute a function of an original apparatus, it is necessary to return to the original apparatus to execute the function. Furthermore, it is impossible to use the operation unit of the original apparatus while another apparatus executes a function on behalf of it. That is, in an environment where a plurality of users share and use one image forming apparatus, a user who wants to use the image forming apparatus (original apparatus) next has to wait until the function being executed by the alternative apparatus ends.

### SUMMARY OF THE INVENTION

The present invention has been made in consideration of the above conventional problems, and provides an image forming apparatus which can be efficiently used by a plurality of users by enabling execution of functions other than a function executed by another apparatus during execution of the function, and a control method for the image forming apparatus.

According to the first aspect of the present invention, an image forming apparatus capable of executing a plurality of functions, comprising: a determination unit that determines whether an another apparatus can operate a target function to be executed by the image forming apparatus; a display control unit that enables display, wherein the display is used for causing a user to input an instruction for causing the other apparatus to operate the target function, on an operation unit of the image forming apparatus, when the determination unit determines that the other apparatus can operate the target function; a transmission unit that transmits information, wherein the information is used by the other apparatus in order to operate the target function, to the other apparatus, in response to input the instruction from the user by using the display enabled by the display control unit; and a function execution unit that accepts an operation from the other apparatus, wherein the operation is inputted on the other apparatus by using the transmitted information, and executes the target function, wherein in response to input the instruction from the user by using the display enabled by the display control unit, the display control unit controls a default screen on the operation unit so as to being capable of newly operating for executing a function, and the function execution unit accepts, from the operation unit, an operation related to a function different from that which is operated from the other apparatus and which is being executed, and executes the different function.

According to the second aspect of the present invention, a control method of an image forming apparatus capable of executing a plurality of functions, comprising: a determination step of determining whether an another apparatus can operate a target function to be executed by the image forming apparatus; a display control step of enabling display, wherein the display is used for causing a user to input an instruction for causing the other apparatus to operate the target function, on an operation unit of the image forming apparatus, when it is determined in the determination step that the other apparatus can operate the target function; a transmission step of transmitting information, wherein the information is used by the other apparatus in order to operate the target function, to the other apparatus, in response to input the instruction from the user by using the display enabled in the display control step; and a function execution step of accepting an operation from the other apparatus, wherein the operation is inputted on the other apparatus by using the transmitted information, and executing the target function, wherein in response to input the instruction from the user by using the display enabled in the display control step, in the display control step, a default screen on the operation unit is controlled so as to being capable of newly operating for executing a function, and in the function execution step, from the operation unit, an operation related to a function different from that which is operated from the other apparatus and which is being executed is accepted, and the different function is executed.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a view showing a configuration example of a network including an image forming apparatus according to an embodiment;

FIG. 2 is a block diagram showing a configuration example of a control unit of the image forming apparatus according to the embodiment;

FIG. 3 is a side sectional view showing a hardware configuration example of a scanner and printer of the image forming apparatus according to the embodiment;

FIG. 4 is a plan view showing a configuration example of an operation unit of the image forming apparatus according to the embodiment;

FIG. 5A-a is a view showing a configuration example of an application program according to the first embodiment;

FIG. 5A-b is a view showing a configuration example of a transfer destination storage unit;

FIG. 5B is a view showing a configuration example of a transfer source storage unit according to the first embodiment;

FIGS. 6A and 6B are views each showing a screen example for setting a transfer destination according to the first embodiment;

FIG. 7A is a flowchart showing a processing procedure of transferring operation to another apparatus according to the first embodiment;

FIG. 7B is a flowchart showing the control procedure of alternative processing by another apparatus and processing of the self apparatus according to the first embodiment;

FIG. 7C is a flowchart showing the procedure of operation processing by another apparatus according to the first embodiment;

FIG. 8 is a view showing an example of a screen on which transfer buttons are displayed according to the first embodiment;

FIG. 9 is a view showing an example of a screen displayed at a transfer destination apparatus according to the first embodiment;

FIG. 10A is a view showing a configuration example of an application program according to the second embodiment;

FIG. 10B is a view showing a configuration example of a transfer destination storage unit according to the second embodiment;

FIGS. 11A-a and 11A-b are views each showing a screen example for managing workflow setting according to the second embodiment;

FIGS. 11B-a to 11B-c are views each showing a screen example for managing execution of workflows according to the second embodiment;

FIG. 12 is a flowchart showing a processing procedure of transferring operation to another apparatus according to the second embodiment;

FIG. 13 is a view showing an example of a screen on which transfer buttons are displayed according to the second embodiment; and

FIG. 14 is a view showing an example of a screen displayed at a transfer destination apparatus according to the second embodiment.

### DESCRIPTION OF THE EMBODIMENTS

An Embodiment for implementing the present invention will be explained with reference to the accompanying drawings hereinafter.

### Configuration Example of Image Processing Network of Embodiment

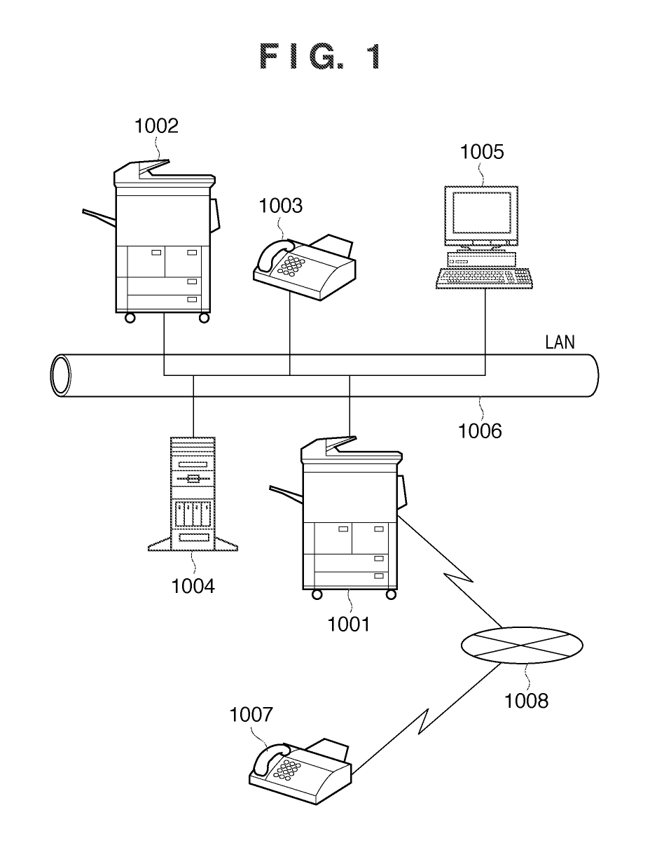

FIG. 1 is a view showing the configuration of a network including an image forming apparatus according to the embodiment of the present invention. The image forming apparatus according to the embodiment serves as an apparatus having a data transmission/reception function.

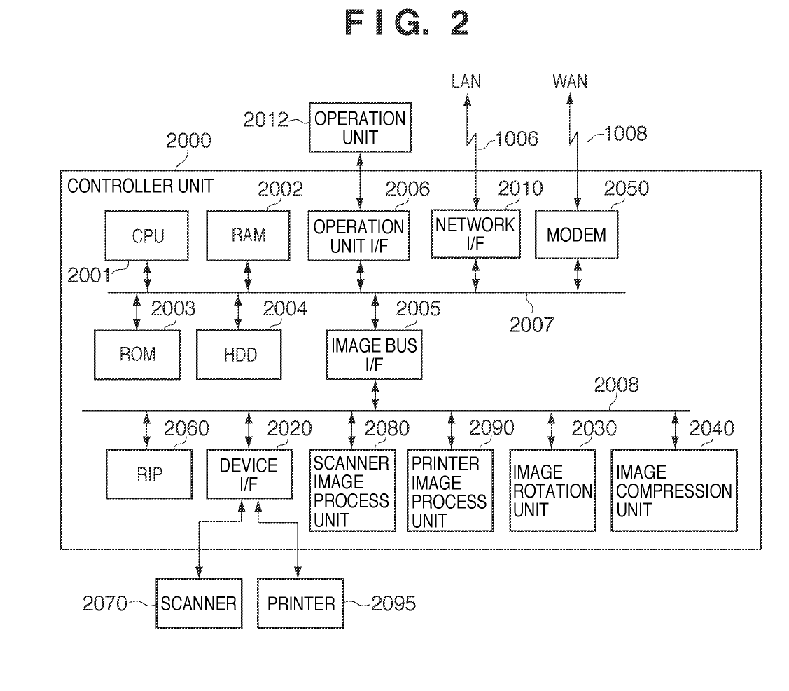

As shown in FIG. 1, an image forming apparatus 1001 is connected to a LAN 1006 formed by a predetermined communication line (for example, Ethernet® and the like). An image forming apparatus 1002 having the same functions as those of the image forming apparatus 1001, a facsimile apparatus 1003, a database/mail server 1004 serving as an information processing apparatus, and a client computer 1005 are also connected to the LAN 1006. The image forming apparatus 1001 connects to a facsimile apparatus 1007 via a public line 1008. In addition to a copy function and a facsimile function, the image forming apparatus 1001 has a data transmission function of reading a document image, and transmitting image data obtained by the reading operation to each apparatus on the LAN 1006. The image forming apparatus 1001 has a PDL (Page Description Language) function, and can, therefore, receive and print a PDL image instructed by a computer connected to the LAN 1006. The image forming apparatus 1001 can save, in a box area designated by an HDD (Hard Disk Drive) 2004 (see FIG. 2) of the image forming apparatus 1001, an image read by the copy function, and a PDL image instructed by a computer on the LAN 1006. Then, the image forming apparatus 1001 can print the image saved in the box area. The image forming apparatus 1001 can also receive, via the LAN 1006, data read by another image forming apparatus 1002, save the received data in its HDD 2004, and print out the data. Furthermore, the image forming apparatus 1001 can receive an image of the database/mail server 1004 via the LAN 1006, save the received data in its storage device, and print out the data.

The facsimile apparatus 1003 can receive, via the LAN 1006, data read by the image forming apparatus 1001, and transmit the received data. The database/mail server 1004 serves as a server apparatus having functions of receiving, via the LAN 1006, data read by the image forming apparatus 1001, storing the received data as a database, and transmitting the data as e-mail. When connecting to the database/mail server 1004, the client computer 1005 can acquire desired data from the database/mail server 1004, and display it. The client computer 1005 can also receive, via the LAN 1006, data read by the image forming apparatus 1001, and manipulate and edit the received data. The facsimile apparatus 1007 can receive, via the public line 1008, data read by the image forming apparatus 1001, and print out the received data.

### Configuration Example of Image Forming Apparatus of Embodiment

### Configuration Example of Control Unit

FIG. 2 is a block diagram showing the configuration of a control unit of the image forming apparatus 1001. The image forming apparatus 1001 includes a controller unit 2000. The controller unit 2000 connects to an operation unit 2012 as well as a scanner 2070 serving as an image input device and a printer 2095 serving as an image output device. The controller unit 2000 controls to implement a copy function of printing out, by the printer 2095, image read by the scanner 2070. By connecting to the LAN 1006 and public line (WAN) 1008, the controller unit 2000 controls to input/output image information and device information.

More specifically, the controller unit 2000 has a CPU 2001. The CPU 2001 starts up an operating system (OS) using a boot program stored in a ROM 2003. The CPU 2001 executes application programs stored in the HDD 2004 on the OS, thereby performing various processes. A RAM 2002 is used as a work area for the CPU 2001. In addition to the work area, the RAM 2002 provides an image memory area for temporarily storing image data. The HDD 2004 stores the application programs and image data. The ROM 2003 and the RAM 2002 are connected to the CPU 2001 via a system bus 2007. An operation unit I/F (operation unit interface) 2006, a network I/F (network interface) 2010, a modem 2050, and an image bus I/F (image bus interface) 2005 are also connected to the CPU 2001 via the system bus 2007.

The operation unit I/F 2006 serves as an interface to the operation unit 2012 having a touch panel, and outputs, to the operation unit 2012, image data to be displayed on the operation unit 2012. The operation unit I/F 2006 sends, to the CPU 2001, information input by the user via the operation unit 2012. The network I/F 2010 is connected to the LAN 1006, and inputs/outputs information from/to each apparatus on the LAN 1006 via the LAN 1006. The modem 2050 is connected to the public line 1008, and inputs/outputs information via the public line 1008. The image bus I/F 2005 is a bus bridge which connects the system bus 2007 to an image bus 2008 for transferring image data at high speed, and converts the data format. The image bus 2008 is formed from a PCI bus or IEEE1394 bus.

A raster image processor (to be referred to as “RIP” hereinafter) 2060, a device I/F 2020, a scanner image process unit 2080, a printer image process unit 2090, an image rotation unit 2030, and an image compression unit 2040 are arranged on the image bus 2008. The RIP 2060 rasterizes a PDL code into a bitmap image. The device I/F 2020 is connected with the scanner 2070 and the printer 2095, and executes synchronous/asynchronous conversion of image data. The scanner image process unit 2080 performs correction, manipulation, and edit for input image data. The printer image process unit 2090 performs correction, resolution conversion, and the like corresponding to the printer 2095 for print output image data. The image rotation unit 2030 rotates image data. The image compression unit 2040 compresses multilevel image data into JPEG data, and binary image data into JBIG, MMR, or MH data or the like, and also decompresses compressed image data.

### Hardware Configuration Example of Scanner and Printer

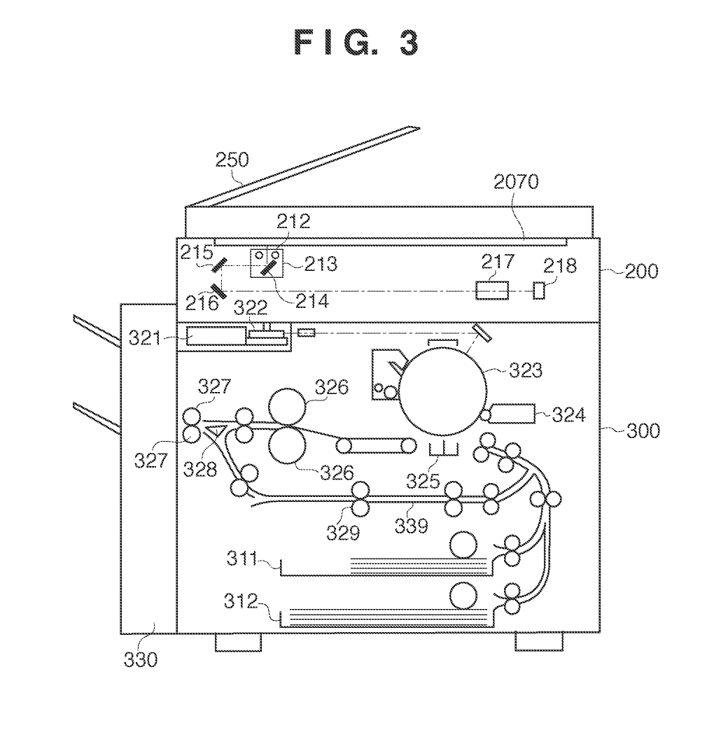

Referring to FIG. 3, the hardware configuration of the scanner 2070 and printer 2095 of the image forming apparatus according to the embodiment will be explained next. FIG. 3 is a side sectional view showing the hardware configuration of the scanner 2070 and printer 2095 shown in FIG. 2. As shown in FIG. 3, the scanner 2070 and printer 2095 are integrated.

The scanner 2070 includes a document feed unit 250. The document feed unit 250 feeds document sheets one by one sequentially from the top onto a platen glass (not shown). Every time each document sheet is read, it is discharged from the platen glass onto a discharge tray (not shown). When a document sheet is fed onto the platen glass, the scanner 2070 turns on a lamp 212 to start moving a moving unit 213. As the moving unit 213 moves, the document sheet on the platen glass is read and scanned. During the read scanning, light reflected by the document sheet is guided to a CCD image sensor (to be referred to as “CCD” hereinafter) 218 via mirrors 214, 215, and 216 and a lens 217, thereby forming an image on the document sheet onto the image sensing surface of the CCD 218. The CCD 218 converts the image formed on the image sensing surface into an electrical signal. The electrical signal undergoes predetermined processing, and is input to the control device (the controller unit shown in FIG. 2).

The printer 2095 includes a laser driver 321. The laser driver 321 drives a laser emitting unit 322 based on image data input from the control device. Then, the laser emitting unit 322 emits a laser beam corresponding to the image data. While scanned, the laser beam irradiates a photosensitive drum 323. An electrostatic latent image is formed on the photosensitive drum 323 by the laser beam. The electrostatic latent image is visualized as a toner image by toner supplied from a developing unit 324. In synchronism with the laser beam irradiation timing, a printing paper sheet is fed from a cassette 311 or 312 via a path to the gap between the photosensitive drum 323 and a transfer unit 325. The transfer unit 325 transfers the toner image on the photosensitive drum 323 onto the fed printing paper sheet. The printing paper sheet on which the toner image has been transferred is sent by a conveying belt to a pair of fixing rollers (heating roller and pressing roller) 326. The pair of fixing rollers 326 press the printing paper sheet by heat to fix the toner image on the printing paper sheet onto it. The printing paper sheet having passed through the pair of fixing rollers 326 is discharged by a pair of discharge rollers 327 to a discharge unit 330. The discharge unit 330 includes a sheet processing device capable of performing post processes such as sorting and stapling. When the two-sided printing mode is set, the printing paper sheet is conveyed to the pair of discharge rollers 327. Then, the rotational direction of the pair of discharge rollers 327 is reversed to guide the printing paper sheet to a re-feeding path 339 by a flapper 328. The printing paper sheet guided to the re-feeding path 339 is fed again to the gap between the photosensitive drum 323 and the transfer unit 325 at the above-described timing, thereby transferring the toner image on the back surface of the printing paper sheet.

### Configuration Example of Operation Unit

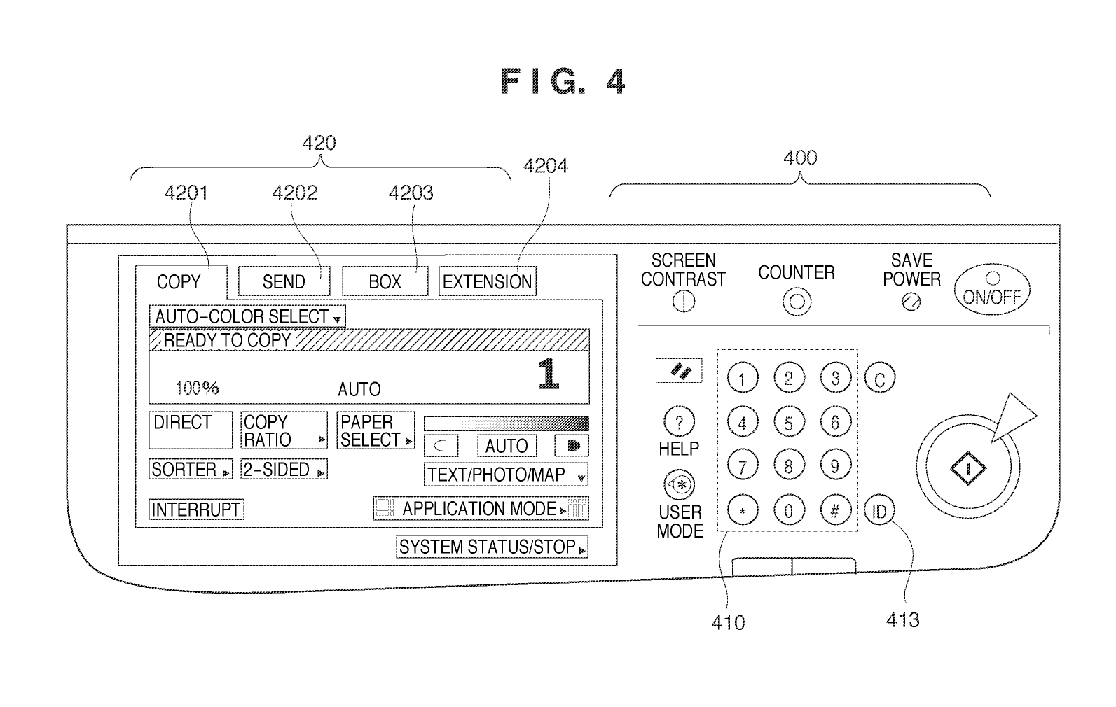

FIG. 4 is a schematic view showing the operation unit 2012 of the image forming apparatus 1001 of the embodiment. FIG. 4 shows the operation unit of the image forming apparatus, which is formed by a key input unit 400 and a touch panel unit 420. The buttons of the touch panel unit 420 and the keys of the key input unit 400 used in the embodiment will be explained below. Note that other buttons and keys are not used in the embodiment, and a description thereof will be omitted. A ten-key pad 410 of the key input unit 400 is used for registering various settings. For example, the ten-key pad 410 is used for inputting the number of sheets to be printed. In order to authenticate the user (operator) of the image forming apparatus 1001, an ID key 413 is used for making the user input a preset personal identification number. It is possible to previously register, in the image forming apparatus 1001, a user name (or ID) and personal identification number, information on a client computer used by the user, and the like. To use the image forming apparatus 1001, the user performs authentication processing by inputting his/her user name (or ID) and personal identification number to log in, and then starts operation. The touch panel unit 420 represents an LCD (Liquid Crystal Display) and a touch panel display formed by a transparent electrode placed thereon. The touch panel unit 420 is previously programmed to display another operation screen upon detecting touching of part of the transparent electrode corresponding to the keys displayed on the LCD. FIG. 4 shows a screen when a copy tab 4201 is selected, and it is possible to display various operation screens in accordance with setting operation. The copy tab 4201 is a tab key to transit to the operation screen of copy operation. A send tab 4202 is a tab key to transit to an operation screen to instruct send operation such as facsimile or e-mail send operation. A box tab 4203 is a tab key to transit to a screen to input/output a job to/from a box (a storage unit for storing jobs for each user). An option (extension in FIG. 4) tab 4204 is a tab key to add/set extensions such as scanner setting, transfer destination setting, and a workflow process function.

### First Embodiment

### Configuration Example of Application Program of First Embodiment

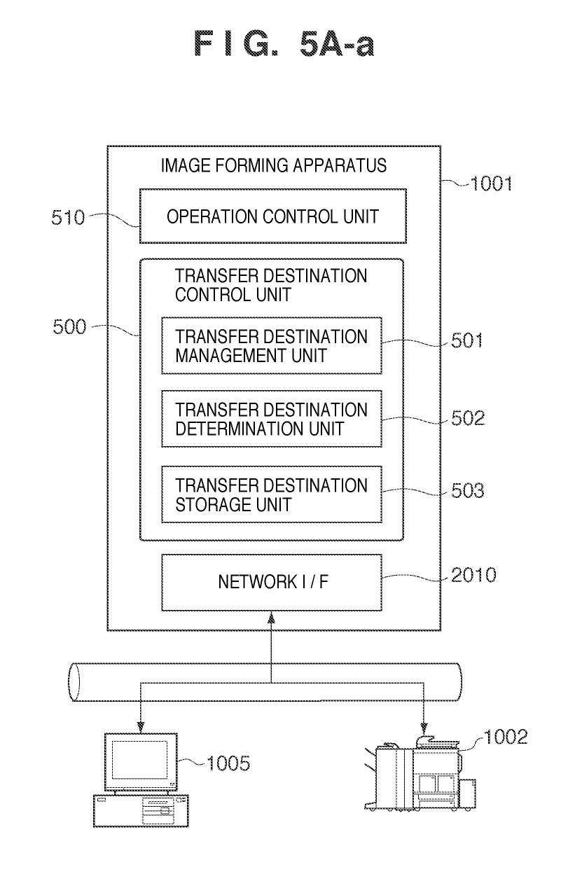

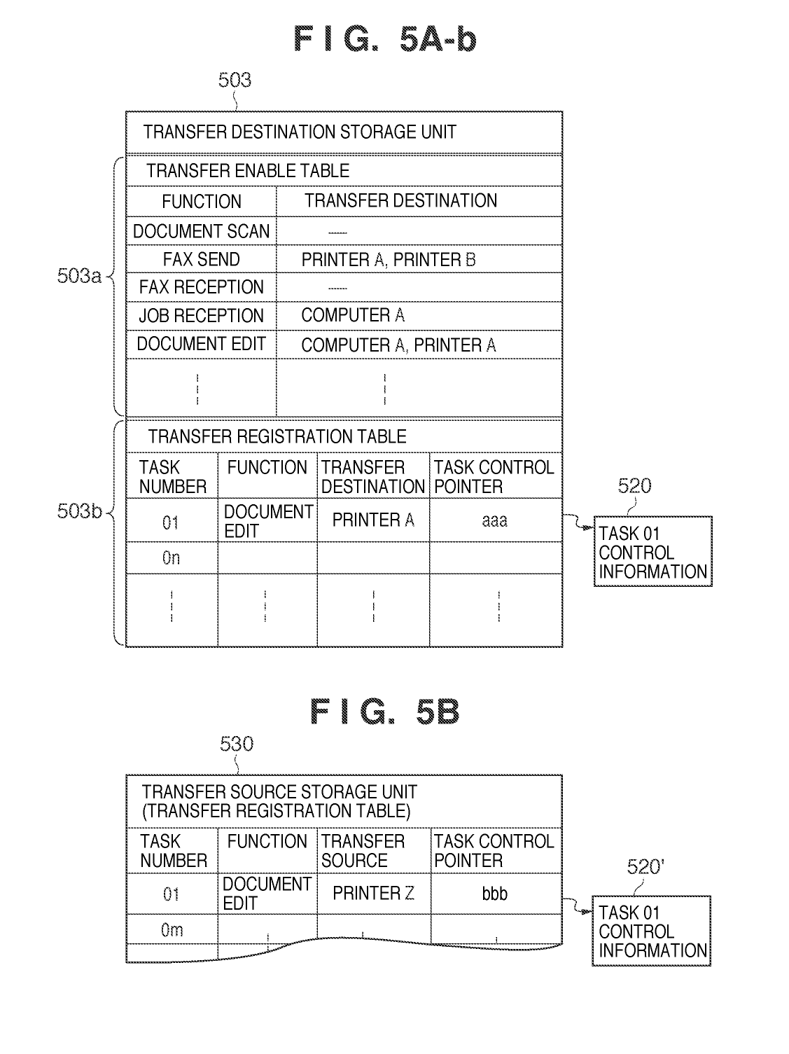

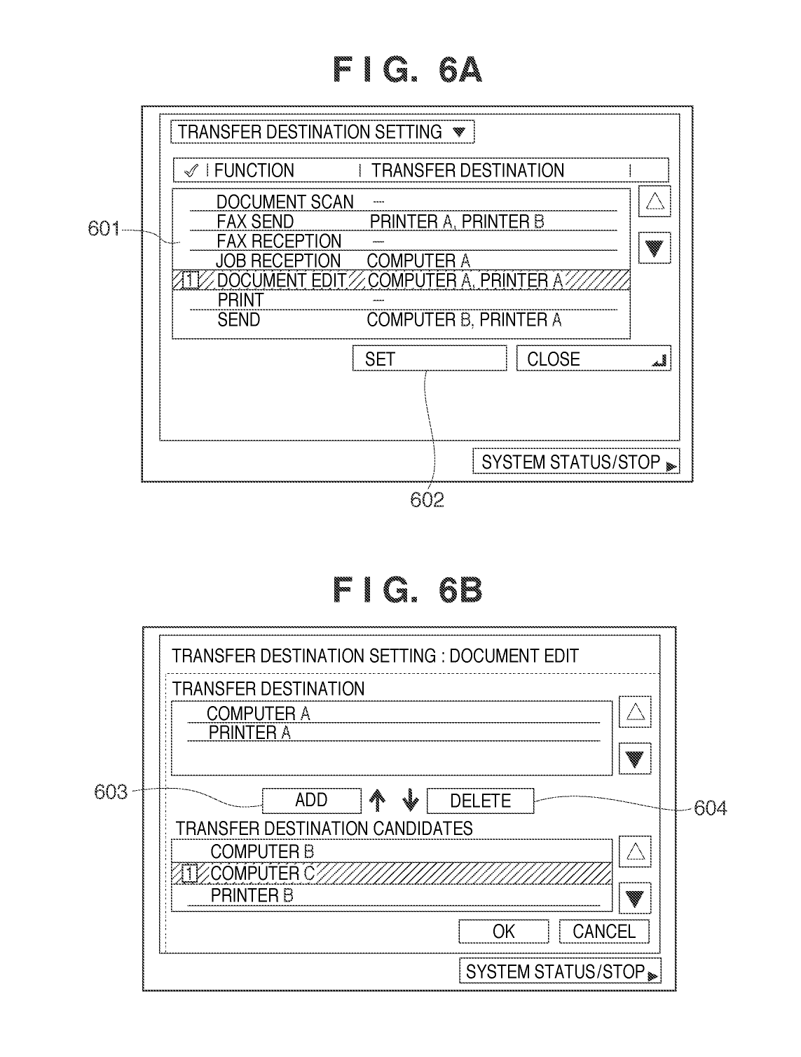

FIG. 5A-a is a view showing the configuration of an application program for implementing processing executed within the image forming apparatus 1001 according to the first embodiment. The application program is stored in the HDD 2004, loaded in the RAM 2002, and executed by the CPU 2001. Referring to FIG. 5A-a, reference numeral 500 denotes a transfer destination control unit for controlling to transfer user operation in the image forming apparatus according to the first embodiment to the client computer 1005 or another image forming apparatus 1002, which then performs the operation. The transfer destination control unit 500 has a management unit 501, a transfer destination determination unit 502, and a transfer destination storage unit 503. The management unit 501 displays information about the transfer operation on the touch panel unit 420 of the operation unit 2012 via the operation unit I/F 2006. The management unit 501 also receives, via the operation unit I/F 2006, the transfer information input to the operation unit 2012 by the user, and stores the information in the transfer destination storage unit 503. The management unit 501 transmits/receives, via the network I/F 2010, the information about transfer to the client computer 1005 or another image forming apparatus 1002. The transfer destination determination unit 502 receives current operation information (a function being operated) in the operation unit 2012 via the operation unit I/F 2006, and determines based on the information stored in the transfer destination storage unit 503 whether it is possible to transfer a function. The transfer destination storage unit 503 stores transfer destination setting information set through the operation unit 2012 by the user, and the current state of operation transfer to another apparatus. A storage configuration example of the transfer destination storage unit 503 will be described below with reference to FIG. 5A-b. Referring to FIG. 5A-a, reference numeral 510 denotes an operation control unit for controlling, when operation is transferred to another apparatus, to enable parallel execution of the operation from another apparatus and that of the self apparatus.

### Configuration Example of Transfer Destination Storage Unit 503

FIG. 5A-b shows an example of the information stored in the transfer destination storage unit 503. The transfer destination storage unit 503 has a transfer destination management table 503a storing, in association with each other, the functions of the image forming apparatus and apparatuses connected to a network to which each function can be transferred. The transfer destination storage unit 503 also has a transfer destination registration table 503b storing, in association with each other, the functions of the image forming apparatus, tasks each executing one of the functions, and apparatuses each of which is executing the operation of each task on behalf of the self apparatus.

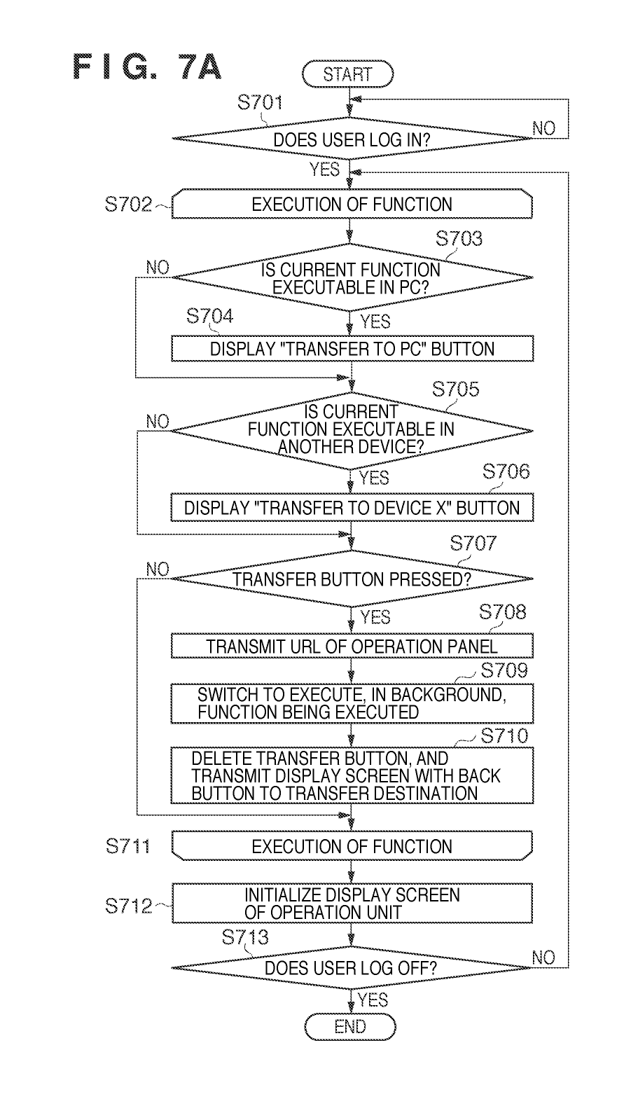

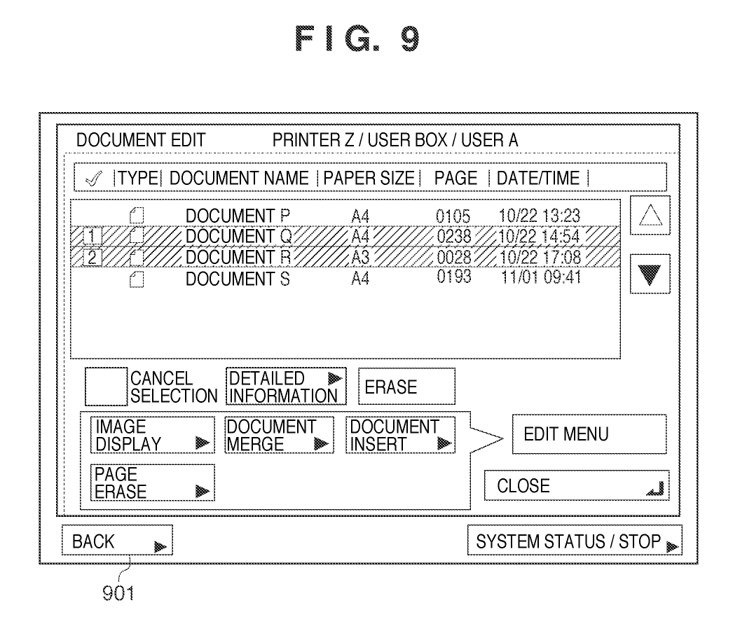

The contents of the transfer destination management table 503a correspond to a display screen shown in FIG. 6A, and can be changed by the user, as shown in FIG. 6B. Note that a transfer instruction screen shown in FIG. 8 displays, among transfer destination apparatuses registered in the transfer destination management table 503a, apparatuses to which transfer is currently possible. The transfer destination registration table 503b contains the task numbers of functions instructed to be executed in the image forming apparatus, the functions, transfer destination apparatuses, and pointers to task control information. In this embodiment, in the transfer destination registration table 503b, the functions instructed to be executed in the image forming apparatus are managed by the task numbers, and the number of a task for which an operation is executed by another apparatus is associated with task control information 520 storing the current state of the task. By referring to the task control information 520, the function is actually performed in the image forming apparatus in accordance with the operation from another apparatus.

### Configuration Example of Transfer Source Storage Unit of Transfer Destination Apparatus

FIG. 5B shows a configuration example of a transfer source storage unit 530 of a transfer destination apparatus (printer A). The transfer source storage unit 530 stores data received from a transfer source apparatus (an apparatus (printer Z) which manages FIG. 5A-b) in transfer. That is, FIG. 5B shows that a function with task number 01 of the transfer destination registration table 503b has been transferred. Task number 01 is associated with a copy 520′ of the task 01 control information.

### Setting Example of Transfer Destination Management Table 503a

FIGS. 6A and 6B are views each showing a screen for setting a transfer destination on the operation unit 2012 of the image forming apparatus 1001 according to the embodiment. Upon pressing the option tab 4204 of the operation unit 2012, a transfer destination setting screen shown in FIG. 6A is displayed. The transfer destination setting screen displays, as a transfer destination list 601, functions executable in the image forming apparatus, and information of the client computer and another image forming apparatus as a transfer destination which can execute each function on behalf of the self apparatus. By selecting a function in the transfer destination list 601, and then pressing a “set” button 602, a transfer destination setting screen shown in FIG. 6B is displayed. In FIG. 6B, a transfer destination for a target function is set using an “add” button 603 and a “delete” button 604. Set transfer destination setting information is stored in the transfer destination management table 503a of the transfer destination storage unit 503 of the HDD 2004.

### Processing Procedure Example of Image Forming Apparatus of First Embodiment

### Procedure Example of Transferring Operation to Transfer Destination

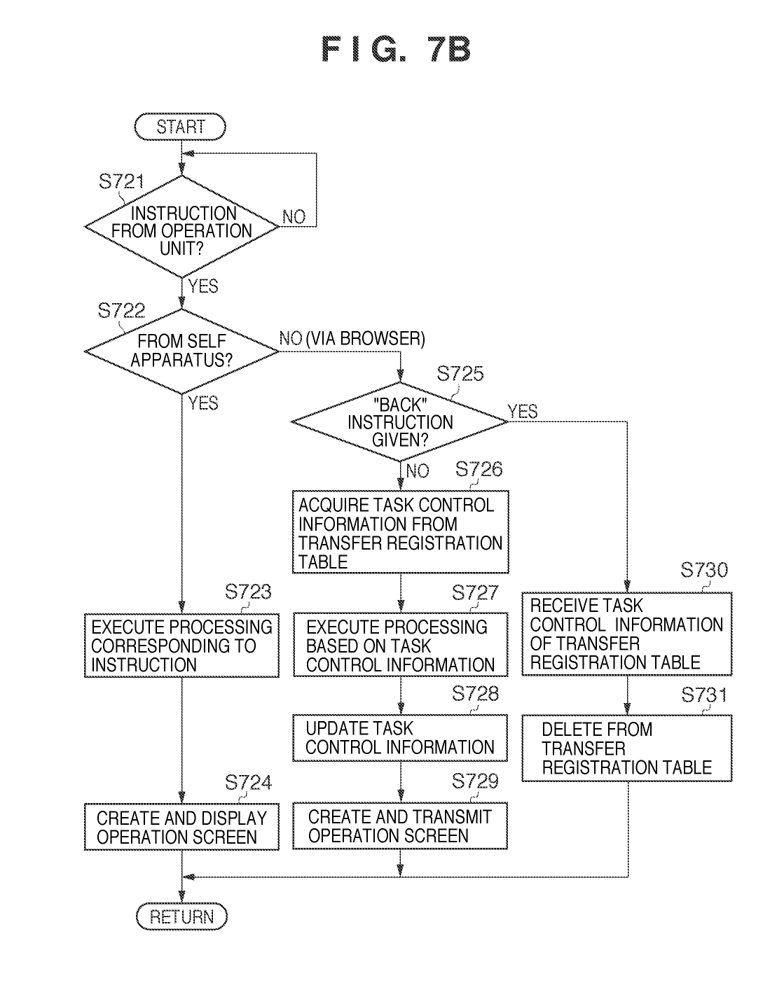

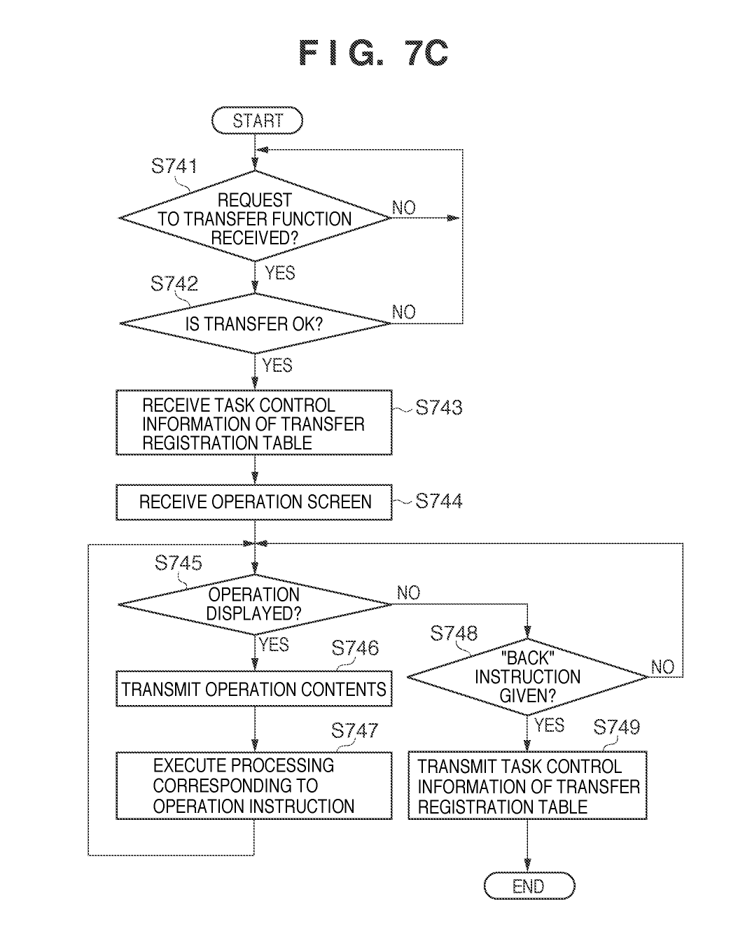

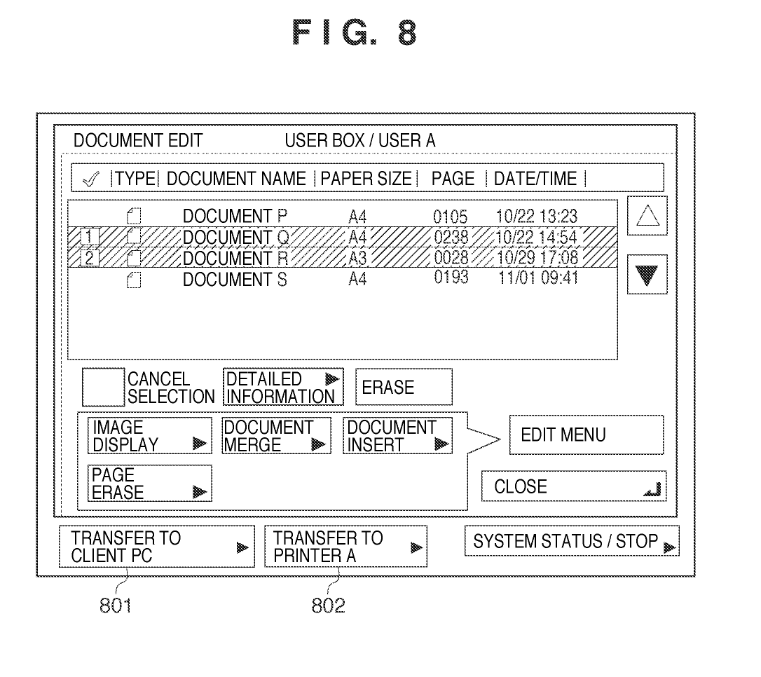

FIG. 7A is a flowchart for explaining a transfer processing sequence in an application program in the image forming apparatus 1001 according to the first embodiment. A program associated with each step is stored in the HDD 2004 of the image forming apparatus 1001, loaded in the RAM 2002, and executed by the CPU 2001. In step S701, the operation unit I/F 2006 detects login of the user by the ID key 413 of the operation unit 2012, and notifies the transfer destination control unit 500 of it. In step S702, the operation unit I/F 2006 notifies the transfer destination control unit 500 of the information of a function being operated through the operation unit 2012 by the user, and starts execution of the function in the image forming apparatus 1001. In step S703, the transfer destination determination unit 502 refers to the transfer destination setting information stored in the transfer destination storage unit 503, and makes function determination whether it is possible to transfer the function being currently operated to the client computer of the login user. If it is possible to transfer the function, the process advances to step S704; otherwise, the process advances to step S705. In step S704, the transfer destination determination unit 502 instructs the operation unit I/F 2006 via the management unit 501 to enable display of a “transfer to client PC” button 801 shown in FIG. 8. The operation unit I/F 2006 provides an instruction for the operation unit 2012 to enable the “transfer to client PC” button 801 on the touch panel unit 420. In step S705, the transfer destination determination unit 502 refers to the transfer destination setting information stored in the transfer destination storage unit 503, and makes function determination whether it is possible to transfer the function being currently operated to another image forming apparatus. If it is possible to transfer the function, the process advances to step S706; otherwise, the process advances to step S707. In step S706, the transfer destination determination unit 502 instructs the operation unit I/F 2006 via the management unit 501 to enable display of a “transfer to <printer name>” (<printer name> is filled with a target image forming apparatus name) button 802 shown in FIG. 8. The operation unit I/F 2006 provides an instruction for the operation unit 2012 to enable the “transfer to <printer name>” button 802 on the touch panel unit 420. Note that display of the “transfer to <printer name>” button 802 may be controlled to be enabled only while the image forming apparatus as a transfer destination is available.

In step S707, the operation unit I/F 2006 detects press of the “transfer to client PC” button 801 or “transfer to <printer name>” button 802 of the operation unit 2012, and notifies the transfer destination control unit 500 of it. If the operation unit I/F 2006 detects press of the button, the process advances to step S708; otherwise, the process advances to step S711. In step S708, the transfer destination control unit 500 transmits information for remotely operating the operation unit 2012, from the network I/F 2010 to the client computer or image forming apparatus as a transfer destination via the management unit 501. For example, the information to be transmitted contains a URL (URI) for remotely accessing the image forming apparatus 1001. A task number instructed to be transferred, a transfer destination, and the like are registered in the transfer destination registration table 503b. In step S709, the transfer destination control unit 500 instructs the operation control unit 510 to execute the function in the background, and the operation control unit 510 switches execution of the transferred function to execution in the background. At this time, the operation unit 2012 changes display of the touch panel unit 420 to a default operation screen (for example, a login screen) in response to an instruction from the operation unit I/F 2006. After that, another user can provide an instruction using the operation unit 2012 and the image forming apparatus 1001 can execute another function.

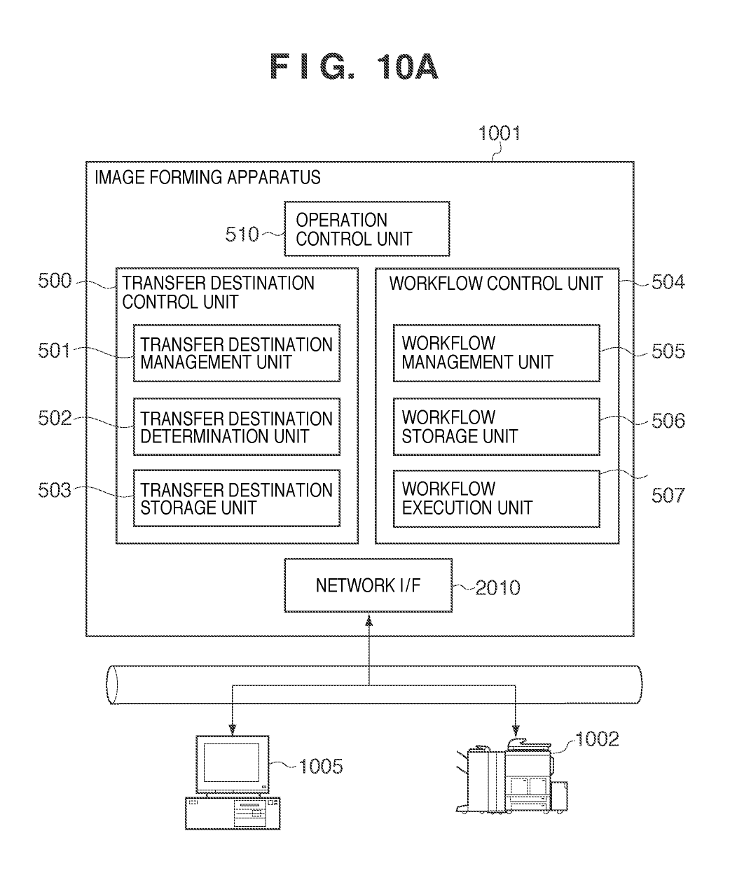

In step S710, the management unit 501 transmits screen information to the transfer destination apparatus which has accessed the self apparatus based on the information transmitted in step S708. In this case, the management unit 501 transmits information for displaying a screen shown in FIG. 9 where the “transfer to client PC” button 801 and (or) the “transfer to <printer name>” button 802 have been deleted from the display screen shown in FIG. 8 and a “back” button 901 has been added. The transmitted information is displayed via a browser of the transfer destination apparatus. In step S711, the operation control unit 510 determines whether execution of the function is complete. If execution of the function is complete, the process advances to step S712. In step S712, the management unit 501 initializes the screen information by clearing display of the “transfer to client PC” button 801 or the “transfer to <printer name>” button 802. In step S713, the operation unit I/F 2006 determines whether the user logs off the operation unit 2012. If the user logs off, the process ends; otherwise, the process returns to step S702.

### Operation Procedure Example of Operation Unit

FIG. 7B is a flowchart for explaining an operation processing sequence in an application program in the image forming apparatus 1001 according to the first embodiment. A program associated with each step is stored in the HDD 2004 of the image forming apparatus 1001, loaded in the RAM 2002, and executed by the CPU 2001. This processing corresponds to that of the operation control unit 510. In step S721, the unit 510 waits for an instruction from the operation unit. Upon reception of an instruction from the operation unit, the unit 510 determines in step S722 whether the instruction is given by the operation unit 2012 of the self apparatus (image forming apparatus 1001) or the operation unit of another apparatus as a transfer destination. If the instruction is given by the operation unit 2012 of the self apparatus, the unit 510 executes processing of a function corresponding to the instruction in step S723. In step S724, the unit 510 creates an operation screen to display a state after the processing, and displays the operation screen on the operation unit 2012. On the other hand, if the instruction is given by the operation unit of another apparatus, the unit 510 determines in step S725 whether the “back” button 901 (see FIG. 9) is pressed. If the “back” button 901 is not pressed, the unit 510 acquires the task control information 520 from the transfer destination registration table 503b based on a task number in step S726. In step S727, the unit 510 instructs execution of processing based on the acquired task control information 520. In step S728, the unit 510 updates the task control information 520. In step S729, the unit 510 creates an operation screen to display a state after the processing, and transmits its screen information to another apparatus. If the “back” button 901 is pressed, the unit 510 receives information on the transfer registration table managed in the transfer source storage unit 530, the task control information 520′, and the like in step S730. In step S731, the unit 510 deletes, from the transfer destination storage unit 503, a function for which processing has been instructed to be returned by the user. The unit 510 then returns the operation of the function of the image forming apparatus 1001 to the operation unit 2012. This allows the user to execute a function in the image forming apparatus 1001 as usual. Note that although the task control information is updated for each operation instruction in FIG. 7B, update may be executed only when the “back” button is operated.

### Processing Procedure Example of Transfer Destination Apparatus

FIG. 7C is a flowchart for explaining a processing sequence in an application program in the image forming apparatus 1002, the client computer 1005, or the like according to the first embodiment. A program associated with each step is stored in the HDD of the image forming apparatus 1002 or the like, loaded in the RAM, and executed by the CPU. In step S741, whether a request to transfer a function is received from the image forming apparatus 1001 is determined. If a request to transfer a function is received, whether the self apparatus can accept transfer of the function is determined in step S742. If the self apparatus can accept transfer of the function, the information registered in the transfer destination registration table 503b and the associated task control information are received in step S743, and stored in the transfer source storage unit 530 shown in FIG. 5B. In step S744, the screen information transmitted in step S710 of FIG. 7A is received, and displayed on the display unit (operation unit). In step S745, whether the received information is an operation instruction of the transferred function is determined. If the received information is an operation instruction of the transferred function, the operation contents are transmitted to the image forming apparatus 1001 as a transfer source in step S746. In step S747, processing corresponding to the operation instruction is executed by acquiring data and the like from the image forming apparatus 1001 as a transfer source, as needed. In step S748, whether the “back” button 901 is pressed is determined. If the “back” button 901 is pressed, the information stored in the transfer source storage unit 530 and the task control information are transmitted to the image forming apparatus 1001 as a transfer source, and the data are deleted. In this case, whether an instruction is given by pressing the “back” button 901 by the user is determined in step S748. At this time, another user may log in the image forming apparatus 1001 as a transfer source, and it may be impossible to return the processing. In the present invention, even after the screen information is received in step S744, a state may be acquired from the apparatus as a transfer source at an arbitrary timing, and then display of the “back” button 901 may be controlled to be enabled/disabled. When the image forming apparatus 1001 accepts a request to return the processing, it may return a response for displaying information “the processing cannot be returned at this time” while another user logs in.

### Display Screen Example in Transfer of First Embodiment

FIG. 8 is a view showing a screen when the “transfer to client PC” button 801 or the “transfer to <printer name>” button 802 is displayed on the operation unit 2012 of the image forming apparatus 1001 according to the first embodiment. In the example shown in FIG. 8, the “transfer to client PC” button 801 and the “transfer to printer A” button 802 are displayed based on the transfer destination setting information during operation of a document edit function.

FIG. 9 is a view showing a screen for displaying an apparatus (the client computer or image forming apparatus) as a transfer destination. This screen is displayed when the “transfer to client PC” button 801 or the “transfer to <printer name>” button 802 is pressed on the operation unit 2012 of the image forming apparatus 1001 (printer Z is assumed) shown in FIG. 8. This screen is displayed when the management unit 501 of the image forming apparatus 1001 transmits screen information to the client computer or image forming apparatus via the network I/F 2010. As for communication information between the image forming apparatus 1001 and the client computer or another image forming apparatus, for example, contents which have been defined by the HTML are transmitted/received through HTTP communication. Referring to FIG. 9, upon detecting press of the “back” button 901, the operation control unit 510 of the image forming apparatus 1001 receives the information, and instructs the operation unit I/F 2006 to return the screen to the operation unit 2012. With this processing, the user can return to the image forming apparatus 1001 to continue the operation. Note that the “back” button 901 is displayed only at a timing when it is possible to return to the image forming apparatus 1001. The timing when it is possible to return to the image forming apparatus 1001 is, for example, a timing when no other user has logged in the image forming apparatus 1001.

### Effects of First Embodiment

As described above, displaying transfer buttons on the operation unit 2012 of the image forming apparatus 1001 enables the user to continue processing in the client computer or another image forming apparatus at an arbitrary timing. This allows a subsequent user to operate the image forming apparatus 1001. The subsequent user can operate the image forming apparatus 1001 without affecting the processing being operated in a transfer destination. This embodiment of the present invention is disclosed using a method of previously registering transfer destinations for each function in the transfer destination storage unit 503. The present invention is also applicable to a method of determining whether transfer to the client computer or another image forming apparatus is possible each time a function is executed, and displaying buttons.

### Second Embodiment

The first embodiment described above discloses an example of the method of determining whether it is possible to transfer operation to the client computer or another image forming apparatus during execution of each function in the image forming apparatus 1001, and displaying, if transfer is possible, buttons associated with transfer. The present invention is also applicable to a case in which the image forming apparatus 1001 executes processing using a workflow that operates a plurality of functions as a series of works. In the second embodiment of the present invention, processing is executed by a workflow. Only the parts different from the first embodiment will be mainly explained in detail with reference to the accompanying drawings. The same reference numerals are given to parts with the same functions as in the first embodiment, and a repetitive description will be omitted.

### Configuration Example of Application Program of Second Embodiment

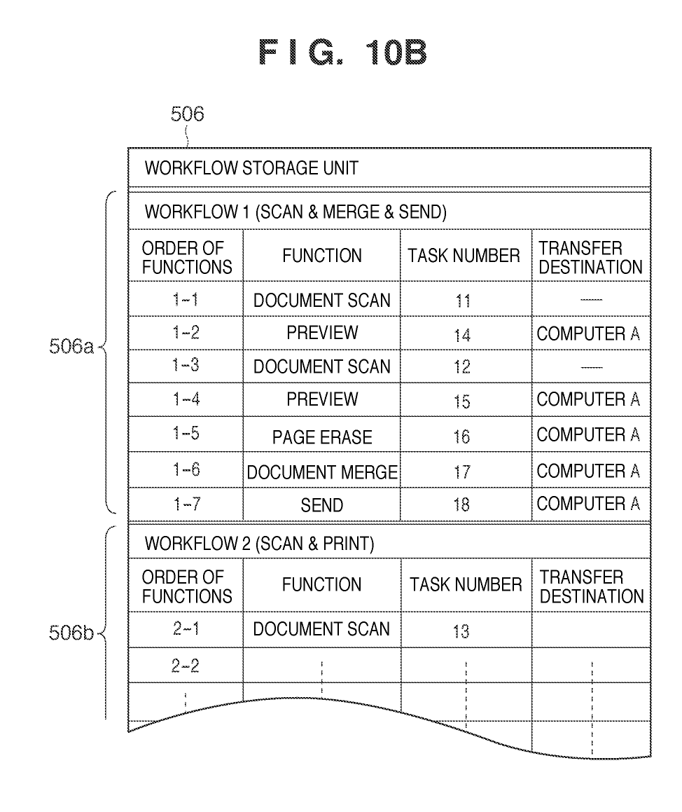

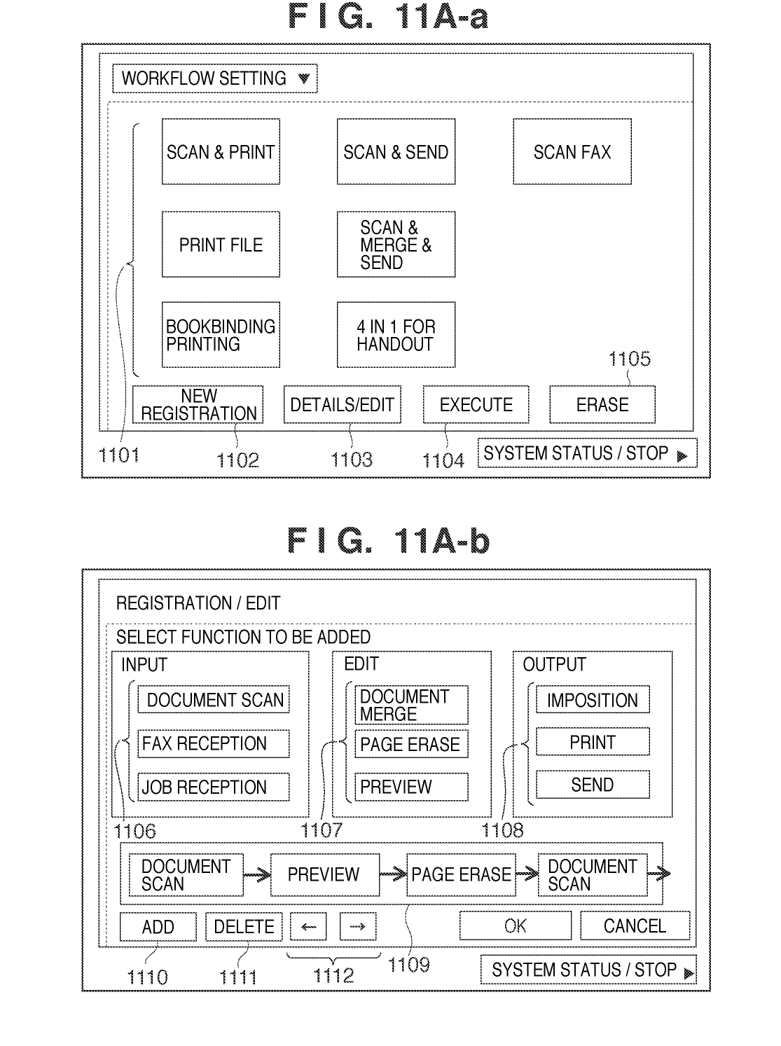

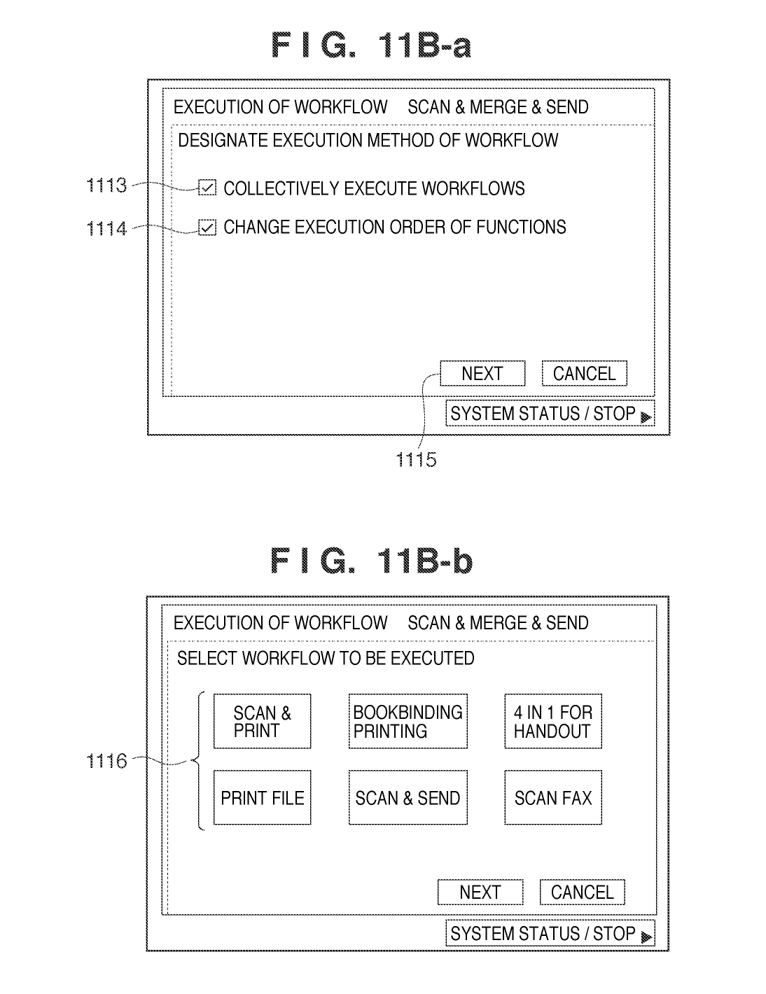

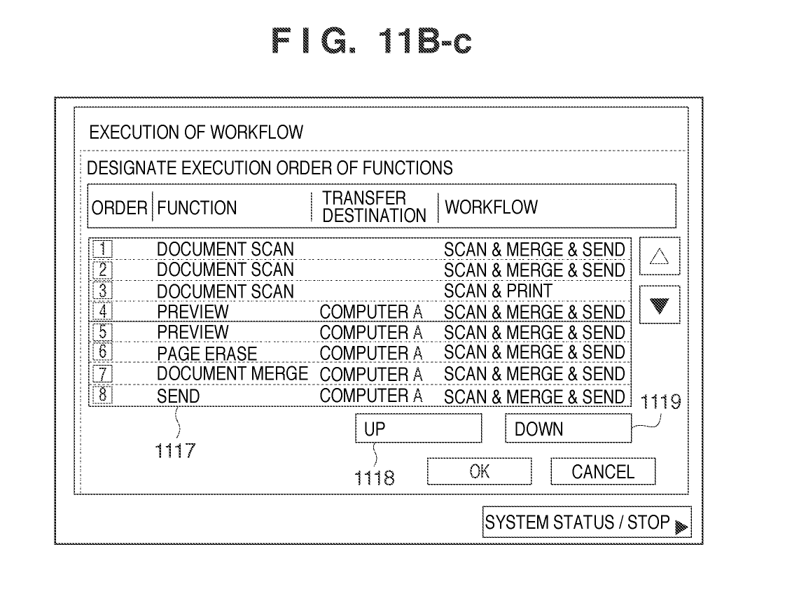

FIG. 10A is a view showing a configuration example of an application program for implementing processing operated within an image forming apparatus 1001. The application program is stored in an HDD 2004, loaded in a RAM 2002, and executed by a CPU 2001. Referring to FIG. 10A, reference numeral 504 denotes a workflow control unit for controlling a workflow in the image forming apparatus 1001 according to the second embodiment. The “workflow” defines a plurality of functions of the image forming apparatus which are created by the user and the execution order of the functions. When executing the workflow, the plurality of functions are sequentially processed in accordance with the execution order. The functions of the image forming apparatus in this embodiment include document scan function, FAX reception function, document merge function, page erase function, imposition function, print function, and SEND (data transmission) function. Each function defined in the workflow will simply be referred to as a function. The workflow control unit 504 controls a workflow management unit 505, a workflow storage unit 506, and a workflow execution unit 507. The workflow management unit 505 manages registration/delete of a workflow in/from the workflow storage unit 506, and change of settings. The workflow storage unit 506 stores the setting information of workflows shown in FIGS. 11A-a and 11A-b which has been set by the user through an operation unit 2012. The workflow execution unit 507 controls execution of workflows in accordance with the execution order of functions in response to a workflow execution instruction provided by the user through the operation unit 2012.

### Configuration Example of Workflow Storage Unit 506

FIG. 10B is a storage example of the workflow storage unit 506. The workflow storage unit 506 stores configurations such as workflow 1 and workflow 2 for each defined workflow. A storage area 506a for workflow 1 stores functions for executing scan & merge & send processing in a process order. The storage area 506a stores a function, a task number, and an operation transfer destination in correspondence with each function number. A storage area 506b of workflow 2 stores functions for executing scan & print processing in a process order. Similarly, the storage area 506b stores a function, a task number, and an operation transfer destination in correspondence with each function number.

### Setting Example of Workflow Storage Unit 506

FIGS. 11A-a and 11A-b are views each showing a screen for managing settings of workflows of the image forming apparatus according to the second embodiment. FIG. 11A-a is a view showing a screen example for setting a workflow. Upon press of an option tab 4204 of the operation unit 2012, a workflow setting screen shown in FIG. 11A-a is displayed, and a workflow is executed by selecting a workflow button 1101 and then pressing an “execute” button 1104. Upon press of a “new registration” button 1102 or press of a “details/edit” button 1103 after selecting a workflow, a registration/edit screen shown in FIG. 11A-b is displayed. Upon press of the “execute” button 1104, workflow execution screens shown in FIGS. 11B-a to 11B-c are sequentially displayed. When selecting a workflow and pressing an “erase” button 1105, the selected workflow is deregistered. The screen shown in FIG. 11A-b is displayed when the “new registration” button 1102 or the “details/edit” button 1103 is pressed in FIG. 11A-a, and is used to register a function in a workflow and edit the workflow. A function is selected from input buttons 1106, edit buttons 1107, and output buttons 1108, and added to a list 1109 by pressing an “add” button 1110. The list 1109 shows functions in an execution order. It is possible to edit the added function using a “delete” button 1111 or move buttons 1112.

### Execution Example of Workflow

FIGS. 11B-a to 11B-c are views each showing a screen example for managing execution of workflows of the image forming apparatus according to the second embodiment. The screen shown in FIG. 11B-a is displayed when the “execute” button 1104 shown in FIG. 11A-a is pressed, and is used to set a method of executing workflows. Whether a plurality of workflows are to be collectively executed (1113) and whether the execution order of the functions is to be changed (1114) are designated. If collective execution of a plurality of workflows is designated, the workflow selection screen shown in FIG. 11B-b is displayed upon press of a “next” button 1115. If changing of the execution order of the functions is designated, the execution order designation screen shown in FIG. 11B-c is displayed upon press of the “next” button 1115. If both of them are designated, the screen shown in FIG. 11B-b is displayed, and then the screen shown in FIG. 11B-c is displayed. FIG. 11B-b shows the workflow selection screen for selecting workflows to be collectively executed. The workflows to be collectively executed are selected using workflow buttons 1116.

FIG. 11B-c shows the execution order designation screen for designating the execution order of the functions. The order of the functions is changed by selecting a function from a function list 1117, and pressing an “UP” button 1118 or a “DOWN” button 1119. For example, FIG. 11B-c shows a case in which collectively executing workflow 1 (scan & merge & send) and workflow 2 (scan & print) shown in FIG. 10B is designated. The order is changed so that the document scan function of workflow 1 and that of workflow 2 are sequentially executed in the image forming apparatus 1001. Consequently, the order of processes is changed as indicated by the task numbers shown in FIG. 10B. The processes from a preview function to a send function can be transferred to, and executed by the client computer or another image forming apparatus. As described above, it becomes possible to collectively execute a plurality of workflows, and to change the order of the functions. This allows to collectively operate (process) functions operable only in the image forming apparatus 1001 first. Then, the remaining functions can be transferred to, and operated by the client computer or another image forming apparatus. The transfer destination can collectively operate the remaining functions. This implements more efficient execution of workflows.

### Processing Procedure Example of Image Forming Apparatus of Second Embodiment

### Procedure Example of Transferring Operation to Transfer Destination

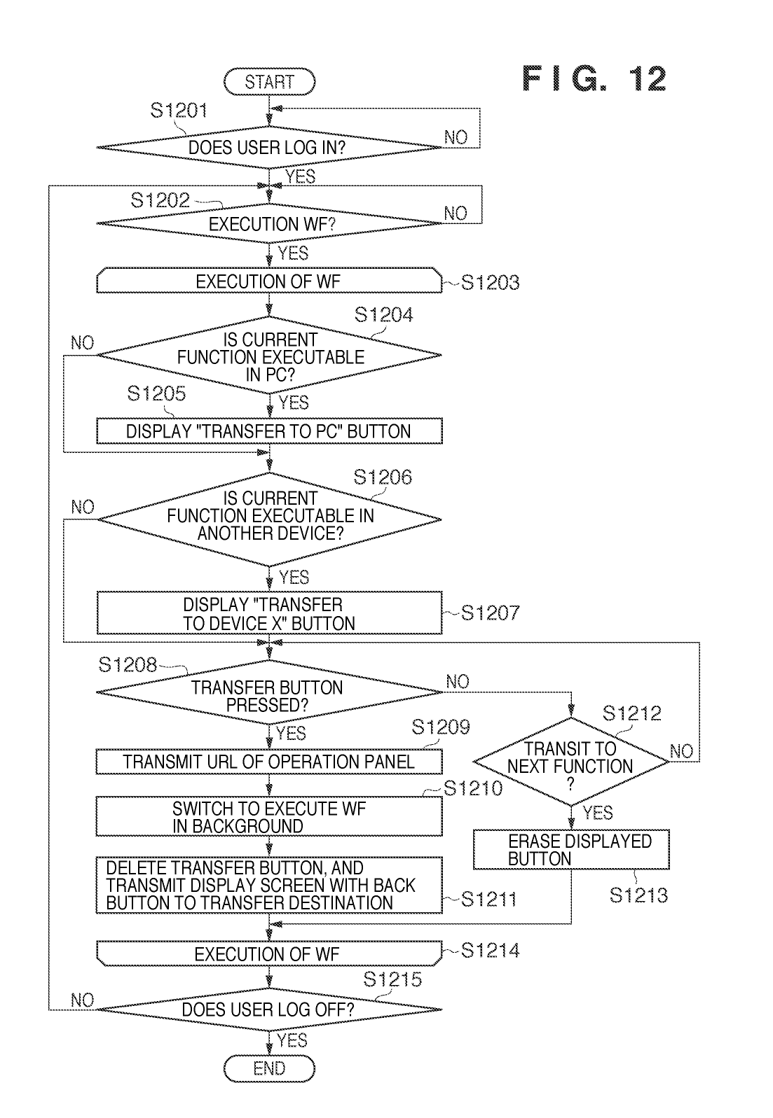

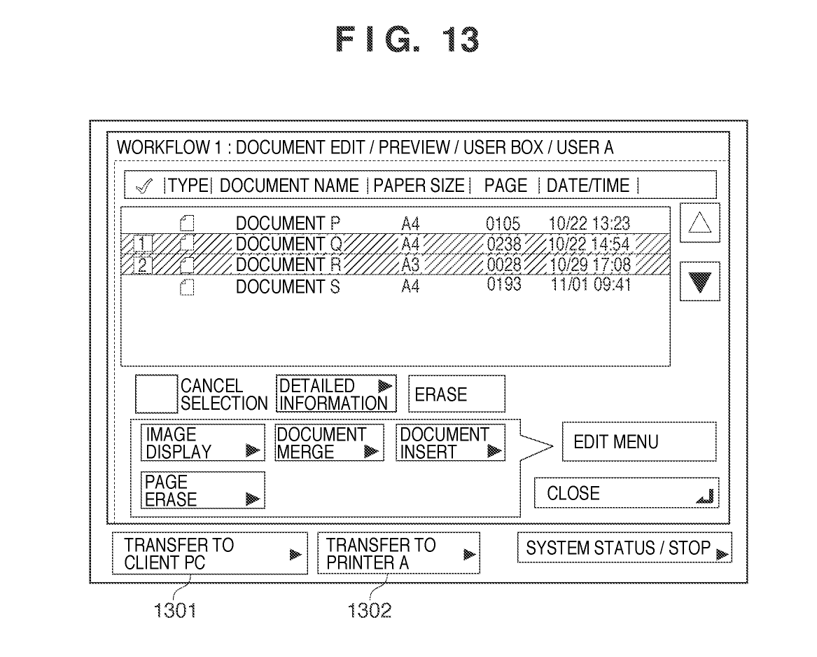

FIG. 12 is a flowchart for explaining a transfer processing sequence in an application program in the image forming apparatus 1001 according to the second embodiment. A program associated with each step is stored in the HDD 2004 of the image forming apparatus 1001, loaded in the RAM 2002, and executed by the CPU 2001. In step S1201, an operation unit I/F 2006 detects login of the user by an ID key 413 of the operation unit 2012, and notifies a transfer destination control unit 500 and the workflow control unit 504 of it. In step S1202, the operation unit I/F 2006 determines whether the operation unit 2012 accepts a workflow execution instruction. If the unit 2012 accepts a workflow execution instruction, the transfer destination control unit 500 and the workflow control unit 504 are notified of information on the executed workflows, and the process advances to step S1203. In step S1203, a workflow execution unit 507 starts execution of the workflows by performing the functions in the order (if the order is not designated, the order stored in the workflow storage unit 506) designated in FIG. 11B-c. In step S1204, the workflow control unit 504 notifies the transfer destination control unit 500 of information on a function being currently executed. The transfer destination control unit 500 notifies a transfer destination determination unit 502 of the notified information. The transfer destination determination unit 502 refers to transfer destination setting information stored in a transfer destination storage unit 503, and determines whether it is possible to transfer the function being currently operated to the client computer of the login user. If transfer is possible, the process advances to step S1205; otherwise, the process advances to step S1206. In step S1205, the transfer destination determination unit 502 instructs the operation unit I/F 2006 via a management unit 501 to display a “transfer to client PC” button 1301 shown in FIG. 13. The operation unit I/F 2006 provides an instruction for the operation unit 2012 to display the “transfer to client PC” button 1301 on the touch panel unit 420. In step S1206, the transfer destination determination unit 502 refers to the transfer destination setting information stored in the transfer destination storage unit 503, and determines whether it is possible to transfer the function being currently operated to another image forming apparatus. If transfer is possible, the process advances to step S1207; otherwise, the process advances to step S1208. In step S1207, the transfer destination determination unit 502 instructs the operation unit I/F 2006 via the management unit 501 to display a “transfer to <printer name>” (<printer name> is filled with a target image forming apparatus name) button 1302 shown in FIG. 13. The operation unit I/F 2006 provides an instruction for the operation unit 2012 to display the “transfer to <printer name>” button 1302 on the touch panel unit 420. Note that the “transfer to <printer name>” button 1302 may be displayed only while the image forming apparatus as a transfer destination is available.

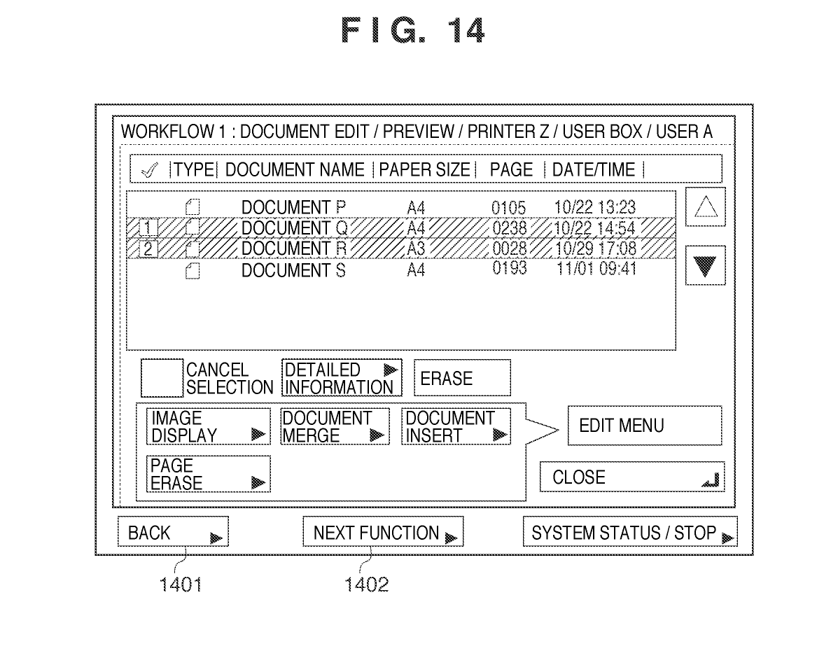

In step S1208, the operation unit I/F 2006 detects press of the “transfer to client PC” button 1301 or “transfer to <printer name>” button 1302 of the operation unit 2012, and notifies the transfer destination control unit 500 of it. If press of the button is detected, the process advances to step S1209; otherwise, the process advances to step S1212. In step S1209, the transfer destination control unit 500 transmits information for operation from the operation unit of another apparatus, from the network I/F 2010 to the client computer or another image forming apparatus as a transfer destination via the management unit 501. For example, the information to be transmitted contains a URL for remotely accessing the image forming apparatus 1001. A task number instructed to be transferred, a transfer destination (and also a workflow number), and the like are registered in the transfer destination registration table 503b shown in FIG. 5B. In step S1210, the transfer destination control unit 500 instructs the operation control unit 510 to execute the function in the background, and the operation control unit 510 switches execution of the transferred function to execution in the background. At this time, the operation unit 2012 changes display of the touch panel unit 420 to a default screen (for example, a login screen) in response to an instruction from the operation unit I/F 2006. After that, another user can provide an instruction using the operation unit 2012. In step S1211, the management unit 501 transmits the screen information to the transfer destination apparatus. In this case, the management unit 501 transmits information for displaying a screen shown in FIG. 14 where the “transfer to client PC” button 1301 and (or) the “transfer to <printer name>” button 1302 have been deleted and a “back” button 1401 has been added. The transmitted information is displayed via a browser of the transfer destination apparatus. In step S1212, whether the transfer destination control unit 500 is notified from the workflow control unit 504 of transition of the process to a next function is determined. If the unit 500 is notified, the process advances to step S1213; otherwise, the process advances to step S1208. In step S1213, the operation unit I/F 2006 clears display of the “transfer to client PC” button 1301 or the “transfer to <printer name>” button 1302 in response to an instruction from the transfer destination control unit 500. In step S1214, the operation control unit 510 determines whether execution of the function is complete. If execution of the function is complete, the process advances to step S1215. In step S1215, the operation unit I/F 2006 determines whether the user logs off the operation unit 2012. If the user logs off, the process ends; otherwise, the process returns to step S1202.

### Operation Procedure Example of Operation Unit and Operation Procedure Example of Transfer Destination Apparatus

An operation procedure example of the operation unit is the same as that shown in FIG. 7B of the first embodiment. In the second embodiment, however, whether to advance to a next function may be instructed from the operation unit. An operation procedure in a transfer destination apparatus is the same as that shown in FIG. 7C of the first embodiment except that workflow information is added.

### Display Screen Example in Transfer of Second Embodiment

FIG. 13 is a view showing a screen when the “transfer to client PC” button 1301 or the “transfer to <printer name>” button 1302 is displayed on the operation unit 2012 of the image forming apparatus 1001 according to the second embodiment. In the example shown in FIG. 13, the “transfer to client PC” button 1301 and the “transfer to printer A” button 1302 are displayed based on the transfer destination setting information during operation of a document edit function.

FIG. 14 is a view showing a screen to be displayed at an apparatus (the client computer or image forming apparatus) as a transfer destination. This screen is displayed when the “transfer to client PC” button 1301 or the “transfer to <printer name>” button 1302 is pressed on the operation unit 2012 of the image forming apparatus 1001 (printer Z is assumed) shown in FIG. 13. This screen is displayed when the management unit 501 of the image forming apparatus 1001 transmits screen information to the client computer or image forming apparatus via the network I/F 2010. As for communication information between the image forming apparatus 1001 and the client computer or another image forming apparatus, for example, contents which have been defined by the HTML are transmitted/received through HTTP communication. Referring to FIG. 14, upon detecting press of the “back” button 1401, the operation control unit 510 of the image forming apparatus 1001 receives the information, and then returns the screen to the operation unit 2012. With this processing, the user can return to the image forming apparatus 1001 to continue the operation. Note that the “back” button 1401 is displayed only at a timing when it is possible to return to the image forming apparatus 1001. The timing when it is possible to return to the image forming apparatus 1001 is, for example, a timing when another user does not log in the image forming apparatus 1001.

The above-described second embodiment discloses the present invention using the method of previously registering transfer destinations for each function in the transfer destination storage unit 503. The present invention, however, is applicable to a method of determining whether it is possible to transfer a function to the client computer or another image forming apparatus each time the function is executed, and displaying buttons. In this case, if an instruction from the user is asked when transferring the function, a “next function” button 1402 is displayed.

### Effects of Second Embodiment

As described above, transfer buttons are displayed on the operation unit 2012 of the image forming apparatus 1001. This enables the user to continue processing in the client computer or another image forming apparatus at an arbitrary timing during execution of a series of workflows, thereby allowing a subsequent user to operate the image forming apparatus 1001. The subsequent user can operate the image forming apparatus 1001 without affecting the processing being operated in a transfer destination. It is also possible to collectively execute a plurality of workflows, and to change the execution order of the functions. This makes it possible to efficiently execute operation in the image forming apparatus 1001 and the client computer or another image forming apparatus as a transfer destination.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-274934 filed Dec. 2, 2009 which is hereby incorporated by reference herein in its entirety.

What is claimed is:

1. An image forming apparatus capable of executing a plurality of functions, comprising:
a determination unit that determines whether an another apparatus can operate a target function to be executed by the image forming apparatus;
a display control unit that enables display, wherein the display is used for causing a user to input an instruction for causing the other apparatus to operate the target function, on an operation unit of the image forming apparatus, when said determination unit determines that the other apparatus can operate the target function;
a transmission unit that transmits information, wherein the information is used by the other apparatus in order to operate the target function, to the other apparatus, in response to input the instruction from the user by using the display enabled by said display control unit; and
a function execution unit that accepts an operation from the other apparatus, wherein the operation is inputted on the other apparatus by using the transmitted information, and executes the target function,
wherein in response to input the instruction from the user by using the display enabled by said display control unit, said display control unit controls a default screen on the operation unit so as to being capable of newly operating for executing a function, and
said function execution unit accepts, from the operation unit, an operation related to a function different from that which is operated from the other apparatus and which is being executed, and executes the different function.

2. The apparatus according to claim 1, wherein said transmission unit transmits a URI of the image forming apparatus as the information.

3. The apparatus according to claim 1, further comprising:
a reception unit that receives, from the other apparatus, an instruction for causing to return an operation authority for executing a function to the image forming apparatus,
wherein if no other operation is performed in the image forming apparatus when said reception unit receives the instruction for causing to return the operation authority to the image forming apparatus, the image forming apparatus executes the function operated by the other apparatus.

4. The apparatus according to claim 1, further comprising:
a process unit that processes a workflow defining the plurality of functions and an execution order of the functions,
wherein said determination unit determines whether the other apparatus can operate each of the functions contained in the workflow, and
when said determination unit determines that the other apparatus can operate a function of interest contained in the workflow, said display control unit enables the display used for causing a user to input an instruction for causing the other apparatus to operate the function of interest at a timing when the function of interest is operated.

5. The apparatus according to claim 4, further comprising a change unit that changes the execution order of the functions in one or a plurality of workflows.

6. The apparatus according to claim 1, wherein the other apparatus serves as a PC of the user which has provided the instruction being based on the display enabled by said display control unit.

7. The apparatus according to claim 1, wherein the other apparatus serves as another image forming apparatus.

8. A control method of an image forming apparatus capable of executing a plurality of functions, comprising:
a determination step of determining whether an another apparatus can operate a target function to be executed by the image forming apparatus;
a display control step of enabling display, wherein the display is used for causing a user to input an instruction for causing the other apparatus to operate the target function, on an operation unit of the image forming apparatus, when it is determined in the determination step that the other apparatus can operate the target function;
a transmission step of transmitting information, wherein the information is used by the other apparatus in order to operate the target function, to the other apparatus, in response to input the instruction from the user by using the display enabled in the display control step; and
a function execution step of accepting an operation from the other apparatus, wherein the operation is inputted on the other apparatus by using the transmitted information, and executing the target function,
wherein in response to input the instruction from the user by using the display enabled in the display control step, in the display control step, a default screen on the operation unit is controlled so as to being capable of newly operating for executing a function, and
in the function execution step, from the operation unit, an operation related to a function different from that which is operated from the other apparatus and which is being executed is accepted, and the different function is executed.

9. A computer-readable storage medium storing a computer program for causing a computer to function as each unit of an image forming apparatus of claim 1.
